(19) United States
(12) Patent Application Publication
(10) Pub. No.: US 2025/0021941 A1
(43) Pub. Date: Jan. 16, 2025

(54) METHODS, APPARATUSES AND COMPUTER PROGRAM PRODUCTS FOR DETERMINING OPTIMIZED PERSONALIZED EXECUTION TIMES FOR DELIVERY OF OPTIMIZED CONTENT

(71) Applicant: Meta Platforms, Inc., Menlo Park, CA (US)

(72) Inventor: Yang Liu, San Jose, CA (US)

(21) Appl. No.: 18/145,153

(22) Filed: Dec. 22, 2022

Related U.S. Application Data
(60) Provisional application No. 63/307,788, filed on Feb. 8, 2022.

(51) Int. Cl. G06Q 10/1093

(52) U.S. Cl. CPC G06Q 10/1097

(57) ABSTRACT

A system for determining personalized execution times for delivery of optimized content is disclosed. The system may evaluate activities of a user, occurring within a network, during hours of days. The system may determine, based on the evaluated activities, optimal time periods during a time interval in which to schedule provision of content items to a communication device(s) associated with the user. The system may determine a best time period among the optimal time periods. The system may generate, in advance of the optimal time periods, content items tailored to the user. The system may determine, in advance of the best time period, a highest ranked generated content item, among the generated content items, for delivery to the communication device(s) associated with the user during the best time period. The system may enable provision, to the communication device(s), of the highest ranked generated content item during the best time period.

### CROSS-REFERENCE TO RELATED APPLICATIONS

This application claims the benefit of U.S. Provisional Patent Application No. 63/307,788, filed Feb. 8, 2022, entitled “Personalized Execution Time Optimization For The Scheduled Jobs,” the entire content of which is incorporated herein by reference.

### TECHNICAL FIELD

Exemplary embodiments of this disclosure relate generally to methods, apparatuses, and computer program products for providing optimized execution times for scheduling delivery of content to communication devices based in part on user activity.

### BACKGROUND

Scheduled batch tasks have been widely used on asynchronous computing platforms to execute various enterprise applications, including scheduled notifications and candidate computations for various recommender systems. A job scheduler or task queue system has largely been deployed in some modern distributed computing architectures to ensure the execution and delivery of tasks for large-scale volume (e.g., billions) process requests. The advantages of scheduled tasks on asynchronous computing architecture may include decoupling from user requests, reduced latency involving requests, better scalability and management with rate-limiting, retry, and priority control. The decoupling from user tasks may relate to the execution of scheduled tasks independent of users' online activities, for example, a task may be completed even in an instance in which an application, associated with the tasks, is not open/launched. Scheduled tasks may particularly be suitable for various complex applications with affordable tolerate delays, such as graph processing, notifications, video encoding services, and language translations. These scheduled tasks may enable scheduled applications to be personalized and executed on a per user basis by providing user information with associated execution timestamps in a task queue associated with a job scheduler. In some networking environments (e.g., social networking), it may be important to deliver or update information to users at the right time to maintain/enhance user experience and to achieve an execution impact associated with the information.

Some modern recommender systems associated with scheduled applications may face dilemmas regarding how to maintain timely updates and quick responses to user actions while consuming scalable infrastructure resources, particularly in view of the exponential growth of massive candidate pools of information to recommend to users. Due to infrastructure resource constraints, it may be a challenge to update candidate generation of information to users at an appropriate time to reflect up-to-date information, particularly for large groups of non-daily active users (e.g., users that may not utilize an application(s) daily).

In view of the foregoing drawbacks, it may be beneficial to provide a versatile personalized execution time optimization solution for recommending information to users while maintaining reasonable infrastructure resource consumption.

### BRIEF SUMMARY

The examples of the present disclosure may facilitate determining optimized times for particular users associated with a network to be sent one or more content items such, as for example, notifications (e.g., messages, Short Message Service (SMS) notifications, Multimedia Message Service (MMS) notifications, emails, application based (e.g., a social network application) notifications (e.g., posts, push content), etc.) and/or other content items. In some examples, the network may be a social network. In other examples, the network may be any suitable network for provisioning content. In this regard, some examples may enable determining a best delivery time(s) for one or more network devices to deliver/provide the content items (e.g., notifications, etc.) to users. In some examples, the best delivery time(s) to deliver/provide the content items may also be determined to be a best time for a particular user to engage/interact with the content items. Additionally, some examples may facilitate determining generation of candidate content to provide to corresponding users during the best delivery times for the users.

Some examples may facilitate monitoring of users' activity patterns associated with a network to determine user activity data associated with corresponding users. For purposes of illustration and not of limitation, some examples may enable determining an instance(s) in which a user typically (e.g., a pattern) visits a network (e.g., a social network) and/or an instance in which the user typically launches an application (app) (e.g., a social networking app). As such, for example, one or more network devices may analyze each hour in a day across a time period (e.g., a week, two weeks, a month, etc.) and may determine how likely a user may visit a network and/or launch an app and may determine how likely (e.g., the likelihood) the user is to respond to (or engage with) received content items (e.g., notifications) during time periods in which the user is determined to be most likely to visit the network and/or launch the app. Accordingly, some examples may generate/provide a best time prediction service to determine the best time to send one or more content items (e.g., messages, notifications, etc.) to users and/or to generate one or more content items for the users to consume (e.g., engage/interact with).

In some aspects of the present disclosure, a method for determining personalized execution times for delivery of optimized content is provided. The method may include evaluating activities of a user, occurring within a network, during hours of one or more days. The method may further include determining, based on the evaluated activities, a plurality of optimal time periods during a time interval in which to schedule provision of corresponding content items to at least one communication device associated with the user. The method may further include determining a best time period among the plurality of optimal time periods. The method may further include generating, in advance of the plurality of optimal time periods, a plurality of content items tailored to the user. The method may further include determining, in advance of the best time period, at least one highest ranked generated content item, among the generated plurality of content items, for delivery to the at least one communication device associated with the user during the best time period. The method may further include enabling provision, to the at least one communication device, of the highest ranked generated content item during the best time period.

In some other aspects of the present disclosure, a system for determining personalized execution times for delivery of optimized content is provided. The system may include one or more processors and one or more memories storing machine-readable instructions that, when executed by the one or more processors, cause the one or more processors to perform operations comprising evaluating activities of a user, occurring within a network, during hours of one or more days. The memory and computer program code are also configured to, with the one or more processors, cause determining, based on the evaluated activities, a plurality of optimal time periods during a time interval in which to schedule provision of corresponding content items to at least one communication device associated with the user. The memory and computer program code are also configured to, with the one or more processors, cause determining a best time period among the plurality of optimal time periods. The memory and computer program code are also configured to, with the one or more processors, cause generating, in advance of the plurality of optimal time periods, a plurality of content items tailored to the user. The memory and computer program code are also configured to, with the one or more processors, cause determining, in advance of the best time period, at least one highest ranked generated content item, among the generated plurality of content items, for delivery to the at least one communication device associated with the user during the best time period. The memory and computer program code are also configured to, with the one or more processors, cause enabling provision, to the at least one communication device, of the highest ranked generated content item during the best time period.

In yet some other aspects of the present disclosure, a computer program product for determining personalized execution times for delivery of optimized content is provided. The computer program product may include at least one computer-readable storage medium having computer-executable program code instructions stored therein. The computer-executable program code instructions may include program code instructions configured to evaluate activities of a user, occurring within a network, during hours of one or more days. The computer program product may further include program code instructions configured to determine, based on the evaluated activities, a plurality of optimal time periods during a time interval in which to schedule provision of corresponding content items to at least one communication device associated with the user. The computer program product may further include program code instructions configured to determine a best time period among the plurality of optimal time periods. The computer program product may further include program code instructions configured to generate, in advance of the plurality of optimal time periods, a plurality of content items tailored to the user. The computer program product may further include program code instructions configured to determine, in advance of the best time period, at least one highest ranked generated content item, among the generated plurality of content items, for delivery to the at least one communication device associated with the user during the best time period. The computer program product may further include program code instructions configured to enable provision, to the at least one communication device, of the highest ranked generated content item during the best time period.

Additional advantages will be set forth in part in the description which follows or may be learned by practice. The advantages will be realized and attainted by means of the elements and combinations particularly pointed out in the appended claims. It is to be understood that both the foregoing general description and the following detailed description are exemplary and explanatory only and are not restrictive, as claimed.

### BRIEF DESCRIPTION OF THE DRAWINGS

The summary, as well as the following detailed description, is further understood when read in conjunction with the appended drawings. For the purpose of illustrating the disclosed subject matter, there are shown in the drawings exemplary embodiments of the disclosed subject matter: however, the disclosed subject matter is not limited to the specific methods, compositions, and devices disclosed. In addition, the drawings are not necessarily drawn to scale. In the drawings:

FIG. 1 is a schematic block diagram of an example system.

FIG. 2 is a block diagram illustrating an example computing device.

FIG. 3 is a diagram of an exemplary communication device.

FIG. 4 is a graph illustrating determined rankings of best times to schedule delivery of content items according to an example.

FIG. 5 is a diagram of an exemplary process for determining personalized execution times for delivery of optimized content in accordance with an example.

FIG. 6 illustrates a machine learning and training model in accordance with an example of the present disclosure.

The figures depict various examples for purposes of illustration only. One skilled in the art will readily recognize from the following discussion that alternative examples of the structures and methods illustrated herein may be employed without departing from the principles described herein.

### DETAILED DESCRIPTION

Some examples of the present disclosure will now be described more fully hereinafter with reference to the accompanying drawings, in which some, but not all examples of the disclosure are shown. Indeed, various examples of the disclosure may be embodied in many different forms and should not be construed as limited to the examples set forth herein. Like reference numerals refer to like elements throughout. As used herein, the terms “data,” “content,” “information” and similar terms may be used interchangeably to refer to data capable of being transmitted, received and/or stored in accordance with examples of the disclosure. Moreover, the term “exemplary.”, as used herein, is not provided to convey any qualitative assessment, but instead merely to convey an illustration of an example. Thus, use of any such terms should not be taken to limit the spirit and scope of examples of the disclosure.

As defined herein a “computer-readable storage medium,” which refers to a non-transitory, physical or tangible storage medium (e.g., volatile or non-volatile memory device), may be differentiated from a “computer-readable transmission medium,” which refers to an electromagnetic signal.

As referred to herein, a “Metaverse” may denote an immersive virtual/augmented reality world in which augmented reality (AR) devices may be utilized in a network (e.g., a Metaverse network) in which there may, but need not, be one or more social connections among users in the network. The Metaverse network may be associated with three-dimensional (3D) virtual worlds, online games (e.g., video games), one or more content items such as, for example, non-fungible tokens (NFTs) and in which the content items may, for example, be purchased with digital currencies (e.g., cryptocurrencies) and other suitable currencies.

As referred to herein, an “asynchronous computing platform” may refer to a computing platform that may process operations independently of other processes.

As referred to herein, an “asynchronous task queue” may refer to a task queue that handles tasks independently, processing data separately and thus may minimize user latency and may ensure that even if a task fails, the remaining tasks/data is processed.

As defined herein, a “recommender device” may refer to a system that may predict suggestions for content items that may be pertinent to a particular user(s) based on one or more user preferences. Recommender devices may perform various decision-making processes and/or may generate recommendations of content items for one or more users. In some examples, content items may include, but are not limited to, messages, notifications, images, videos, advertisements, audio, or other content objects.

As referred to herein, a “candidate pool” may refer to various content items (e.g., social network content items) that a user(s) may view associated with a social network application. In some examples, the content items may also include recent updates of friends of the user(s) and recommended content items generated by, or associated with, a network platform device.

As referred to herein, “candidate content generation” may refer to a process in, or associated with, a recommendation system to generate all, or a subset, of eligible content items stored in a memory device (e.g., a database) that satisfies criteria of a user's request (e.g., a content request).

As referred to herein, a “scheduled batch task(s)” may refer to any asynchronous tasks that are scheduled together in a task queue. In this regard, for example, multiple tasks may be scheduled together for a group of users which may decrease service/network latency.

As referred to herein, a “social network” may refer to an electronic platform for conducting communications between one or more entities over a network, such as, for example, the Internet. A social network may provide many forms of communications, such as, for example, messaging, notifications, posts, etc.

As referred to herein, “off-peak hours” may refer to the time in which activities associated with a network is low and/or nonexistent.

As referred to herein, “non-daily active users” may refer to users who may not actively engage with an application(s) on a daily basis.

As referred to herein, an “application” may refer to a computer software package that may perform specific functions for users and/or, in some cases, for another application(s). An application(s) may utilize an operating system (OS) and other supporting programs to function. In some examples, an application(s) may request one or more services from, and communicate with, other entities via an application programming interface (API).

It is to be understood that the methods and systems described herein are not limited to specific methods, specific components, or to particular implementations. It is also to be understood that the terminology used herein is for the purpose of describing particular embodiments only and is not intended to be limiting.

Many conventional computing platforms may utilize scheduled batch tasks to execute various enterprise practices, including scheduled notifications and candidate computation. However, these conventional computing platforms may fail to provide versatile execution times for user-basis related scheduled tasks to satisfy various product scenarios while maintaining infrastructure resource consumption. In some conventional computing platforms, a common problem may arise in how to maintain timely updates and quick responses to user actions while consuming scalable infrastructure resources. These problems may be more apparent in view of the exponential growth of massive candidate pools of content. In some large-scale web applications, one common method that may be used to mitigate such problems may be periodic candidate content generation, but due to infrastructure resource constraints, it may be a challenge to update the candidate content generation for users at the right time to reflect up-to-date information. The problems with periodic candidate content generation may be particularly apparent for large groups of non-daily active users. Many existing systems may utilize a reinforcement learning approach to optimize a personalized number of execution times for scheduling tasks to balance daily metrics and resource consumption. However, these existing systems may still fail to provide up-to-date information to users.

In some social networking platforms, notifications may be an important recommendation channel to deliver timely information to users. It has been shown that an average user may receive over 65 notifications per day and almost 50% may be considered to interrupt a user's daily tasks. Based on this information, delivery time of notifications may be an important factor for users to improve user experience. Many factors may contribute to user engagement with notifications such as, device context and status, real-time environment, and the content relevance of the notifications. Furthermore, since some existing systems may fail to provide versatile execution times for user-basis scheduled tasks and personalized execution timestamps of up-to-date information, many existing notification systems may fail to provide an optimal user experience.

The examples of the present disclosure may provide optimal personalized execution times for scheduled delivery of content items. One or more platforms of the present disclosure may facilitate monitoring of users' activities and/or usage in coordination with determining a timeframe of the users' activities associated with a channel(s) or an application(s). In this regard, a channel may refer to the media through which information may be delivered to a user(s). Some examples of channels may be a push channel (for push notifications), an email channel (for email), a SMS channel (for SMS messages), etc. The data obtained may then be used to determine one or more optimal time slots to deliver scheduled content items to user devices associated with corresponding users. Additionally, the data obtained may be utilized to determine at least one best time window/slot from the optimal time slots. Some examples may then analyze the optimal time slots in conjunction with the best time slot to predetermine content items for delivery during the optimal time slots and/or the best time slot.

### Exemplary System Architecture

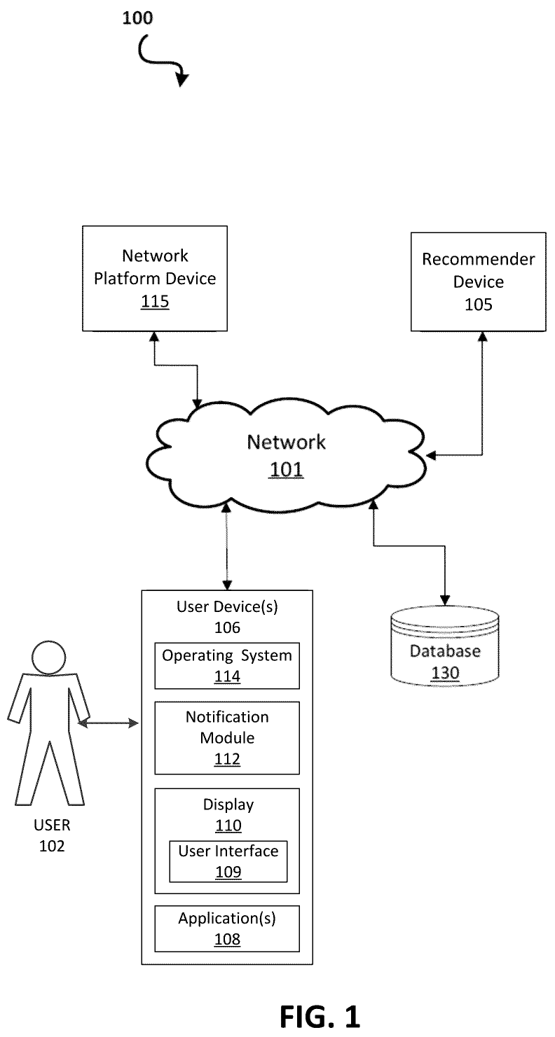

Referring to FIG. 1, a system 100 may include a recommender device 105 (e.g., a server), a network platform device 115 (e.g., a social networking platform device), and a database 130. The system 100 may also include one or more user devices 106 configured with a display 110, a notification module 112, an application(s) 108 and an operating system 114. In some examples, the system 100 may be a Metaverse network. In other examples, the system 100 may be any suitable network configured to provision content and/or communications. The recommender device 105, the network platform device 115, the database 130, and the user device(s) 106 may be in communication with each other via a network 101. The recommender device 105 may also be referred to herein as optimizer device 105. The network 101 may include a wide area network (WAN), such as the Internet, a local area network (LAN), such as, for example, a wireless local area network (WLAN), or other types of networks.

The network platform device 115 may provide a network platform that enables communications, and/or any form of connections between users. In some examples, the network platform may be a social network platform. In some other examples, the network platform may be any suitable network content platform. A user(s) 102 may be an individual (e.g., human user), an entity (e.g., an enterprise, business, or third-party application), or a group (e.g., of individuals or entities) that interact and/or communicate with other users 102 over system 100. In some examples, one or more users 102 may use one or more user devices 106 to access, send data to, and/or receive data across system 100.

The recommender device 105 may be associated with the network platform device 115. For example, in some examples, the recommender device 105 may be maintained by the network platform device 115. In this regard, in some examples, the recommender device 115 may be integrated within the network platform device 115. In some other examples, the recommender device 105 may be maintained by a third party (e.g., an intermediary). In this regard, in some examples, the recommender device 115 may be a standalone device (e.g., separate from the network platform device 115) within system 100. The recommender device 105 may generate, access and/or update a user activity data structure, which may be stored in database 130. In response to updating the user activity data structure, the recommender device 105 may add or remove potential recommended content associated with the user activity data structure tailored for one or more corresponding users 102.

For example, in an instance in which communication may be initiated between a first user on an application (e.g., a social network application, etc.) and a second user via one or more user devices 106 connected to the network platform device 115, the recommender device 105 may receive data of user activities and/or may determine a need to provide a notification(s) to the second user by the network platform device 115. In some examples, the recommender device 105 may access the user activity data to determine whether and/or an instance in which a notification(s) should be provided to a user device 106 associated with a user. The recommender device 105 may analyze the user activity data to determine one or more users associated with the user activity data that may be designated to receive one or more content items such as, for example, notifications (e.g., push notifications), messages or the like. The content items may be sent to a user device (e.g., user device 106) of a corresponding user(s) (e.g., user 102) in an order of predetermined priority such as, for example, a priority level determined by the network platform device 115. For purposes of illustration and not of limitation, consider an example in which a first user may utilize an application to communicate with other users, and may request friends, or other users, to be added to the first user's network or friends list (e.g., a social network friend's list) via the network platform device 115. In this example, the network platform device 115 may determine the timeframe of a second user's activity and may determine a friend relationship status of an individual that the first user may be attempting to communicate with or add as a friend. Based on this data, in an instance in which the first user and the second user may not be friends, the recommender device 105 may determine to notify the second user about potentially adding the first user as a friend in an instance in which the second user is determined to be historically more active on a network (e.g., a social network) based on monitoring user activities associated with the second user determined. In this example, the second user's data indicating the second user is historically more active during a certain time window/period may be determined to be a best time slot for providing content to the second user. In another example, in an instance in which the data indicates that the first user and the second user are friends, a notification may be sent, by the recommender device 105, immediately to the first user and the second user indicating friend relationship. The timing of generating, and/or scheduling delivery of, the notification may be determined, by the network platform device 115 and/or the recommender device 105 based on priority of scheduled content items (e.g., notifications) determined or set by the recommender device 105. In some examples, the priority of the scheduled content items may be determined by the network platform device 115 and/or the recommender device 105.

The database 130 may store content items and other data. In some examples, the database 130 may store monitored user activity data. Some examples of monitored user activity data may include, but are not limited to, the hours of the day one or more users may utilize an application(s) (e.g., the frequency of application usage), when one or more users may be likely to open an app (e.g., via user device 106), when a user(s) may communicate with other users, or any other suitable user activity data that may occur within, or may be associated with, system 100.

The user device 106 may include, for example, a personal computer, a laptop computer, a mobile device (e.g., a mobile phone, a smart tablet), a wearable device or any other suitable device. The user device 106 may include a display 110, one or more applications 108, a notification module 112, and an operating system 114. In some examples, data (e.g., notifications, user activity data, etc.) may be provided by the recommender device 105, the network platform device 115, and/or the database 130 to the notification module 112 (e.g., for presentation or output (e.g., by display 110)). In some examples, the user device 106 may implement or execute an application(s) 108 on user device 106. For instance, in some examples, the application(s) 108 may enable the user device 106 to facilitate communications between users across system 100. In an example, the application(s) 108 may be a social network application(s). In other examples, the application(s) 108 may be any other suitable application(s) (e.g., a content related application).

The operating system 114 may be configured to support and/or manage the functionality of the user device 106. For example, operating system 114 may manage the processing, memory allocation, display presentation functions and other functions of the user device 106. In some examples, application(s) 108 may provide data to the operating system 114 to be rendered and displayed by the display 110. Operating system 114 may also include various other functions, such as managing a file system and a user input interface (UI) (e.g., user interface 109) that may be navigated by a user (e.g., user 102) of the user device 106. In some examples, the user interface 109 may detect input or a selection of a request (e.g., by a user) for information relating to communication between other users associated with a network platform (e.g., a social network platform) facilitated by the network platform device 115. In other examples, the user interface may detect input or selection related to facilitating communications associated with the network platform (e.g., the social network platform) facilitated by the network platform device 115 and may provide an indication to the recommender device 105 that one or more notifications should be sent to at least one user associated with a communication(s).

The operating system 114 may be coupled to the notification module 112 in some examples. In some examples, the notification module 112 may manage notifications to be displayed by the display 110. The notification module 112 may support different types of notifications, such as for example notifications that may be associated with the network platform device 115, the recommender device 105, and/or the application(s) 108. For purposes of illustration and not of limitation, for example, in an instance in which application(s) 108 may be a social network application, the notification module 112 may display a notification(s) that may indicate the name of a user and a reason for the notification (e.g., a message, a friend request, an item of content, or any other communication) to be provided to the user. Similarly, for purposes of illustration and not of limitation, for example, in an instance in which application(s) 108 may be a weather application, the notification module 112 may generate a notification(s) indicating a name of a user and a weather condition to be provided via the notification(s) to the user.

The notification module 112 may also support other types of notifications. One such type of notification may be a displayable pop-up notification that may be displayed in addition to or instead of another notification (e.g., a message, a friend request, an item of content, etc., as described above). In some examples, notifications of various types may optionally be selectable and provided (e.g., by recommender device 105) to a user device to launch a corresponding application(s) 108 for execution by the user device 106. For example, a pop-up notification may be temporarily displayed, by display 110, to notify a user of a show (e.g., a movie) that is about to begin.

### Exemplary Computing Device

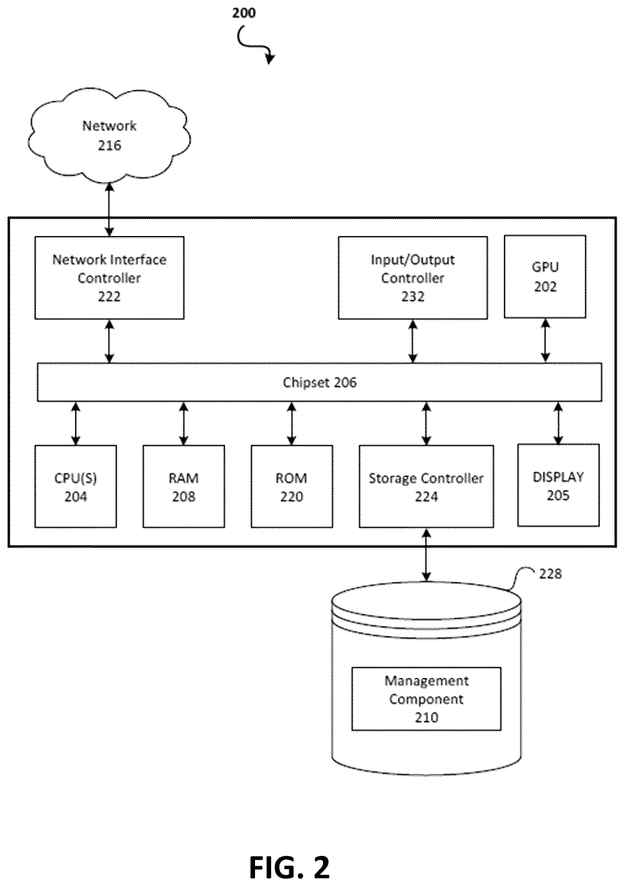

FIG. 2 depicts a computing device that may be used in various aspects, such as the servers, modules, or devices depicted in FIG. 1. With regard to the example architecture of FIG. 1, recommender device 105, network platform device 115, and/or the database 130 may each be implemented in an instance of a computing device 200 of FIG. 2. The computer architecture shown in FIG. 2 may illustrate a server, workstation, desktop computer, laptop, tablet, network appliance, personal data assistant (PDA), e-reader, digital cellular phone, or other computing node, and may be utilized to execute any aspects of the computers described herein, such as to implement the methods described herein.

The computing device 200 may include a baseboard, or “motherboard,” which may be a printed circuit board to which a multitude of components or devices may be connected by way of a system bus or other electrical communication paths. One or more central processing units (CPUs) 204 may operate in conjunction with a chipset 206. The CPU(s) 204 may be standard programmable processors that perform arithmetic and logical operations necessary for the operation of the computing device 200. The computing device 200 may include a graphical processing unit GPU 202 (s). In some examples, the GPU(s) 202 may facilitate generation of one or more images/videos for output to a display device (e.g., display 205).

The CPU(s) 204 may perform the necessary operations by transitioning from one discrete physical state to the next through the manipulation of switching elements that differentiate between and change these states. Switching elements may generally include electronic circuits that maintain one of two binary states, such as flip-flops, and electronic circuits that provide an output state based on the logical combination of the states of one or more other switching elements, such as logic gates. These basic switching elements may be combined to create more complex logic circuits including registers, adders-subtractors, arithmetic logic units, floating-point units, and the like.

The CPU(s) 204 may be augmented with or replaced by other processing units, such as GPU(s) 202. The GPU(s) 202 may comprise processing units specialized for but not necessarily limited to highly parallel computations, such as graphics rendering and other visualization-related processing. In some examples, the GPU(s) 202 may render a user interface(s), which may detect input (e.g., selections of a user) and present/output visible indicia.

A chipset 206 may provide an interface between the CPU(s) 204 and the remainder of the components and devices on the baseboard. The chipset 206 may provide an interface to a random-access memory (RAM) 208 used as the main memory in the computing device 200. The chipset 206 may further provide an interface to a computer-readable storage medium, such as a read-only memory (ROM) 220 or non-volatile RAM (NVRAM) (not shown), for storing basic routines that may help to start up/initiate the computing device 200 and to transfer information between the various components and devices. ROM 220 or NVRAM may also store other software components necessary for the operation of the computing device 200 in accordance with the aspects described herein.

The computing device 200 may operate in a networked environment using logical connections to remote computing nodes and computer systems through a network 216 (e.g., a local area network (LAN), Internet, network 101, etc.). The chipset 206 may include functionality for providing network connectivity through a network interface controller (NIC) 222, such as a gigabit Ethernet adapter. A NIC 222 may be capable of connecting the computing device 200 to other computing nodes over a network 216. It should be appreciated that multiple NICs 222 may be present in the computing device 200, connecting the computing device to other types of networks and remote computer systems.

The computing device 200 may be connected to a mass storage device 228 that provides non-volatile storage for the computer. The mass storage device 228 may store system programs, application programs, other program modules, and data, which are described in greater detail herein. The mass storage device 228 may be connected to the computing device 200 through a storage controller 224 connected to the chipset 206. The mass storage device 228 may consist of one or more physical storage units. A storage controller 224 may interface with the physical storage units through a serial attached SCSI (SAS) interface, a serial advanced technology attachment (SATA) interface, a fiber channel (FC) interface, or other type of interface for physically connecting and transferring data between computers and physical storage units.

The computing device 200 may store data on a mass storage device 228 by transforming the physical state of the physical storage units to reflect the information being stored. The specific transformation of a physical state may depend on various factors and on different implementations of this description. Examples of such factors may include, but are not limited to, the technology used to implement the physical storage units and whether the mass storage device 228 is characterized as primary or secondary storage and the like.

For example, the computing device 200 may store information to the mass storage device 228 by issuing instructions through a storage controller 224 to alter the magnetic characteristics of a particular location within a magnetic disk drive unit, the reflective or refractive characteristics of a particular location in an optical storage unit, or the electrical characteristics of a particular capacitor, transistor, or other discrete component in a solid-state storage unit. Other transformations of physical media are possible without departing from the scope and spirit of the present description, with the foregoing examples provided only to facilitate this description. The computing device 200 may further read information from the mass storage device 228 by detecting the physical states or characteristics of one or more particular locations within the physical storage units.

In addition to the mass storage device 228 described above, the computing device 200 may have access to other computer-readable storage media to store and retrieve information, such as program modules, data structures, or other data. It should be appreciated by those skilled in the art that computer-readable storage media may be any available media that provides for the storage of non-transitory data and that may be accessed by the computing device 200.

By way of example and not limitation, computer-readable storage media may include volatile and non-volatile, transitory computer-readable storage media and non-transitory computer-readable storage media, and removable and non-removable media implemented in any method or technology. Computer-readable storage media may include, but is not limited to, RAM, ROM, erasable programmable ROM (“EPROM”), electrically erasable programmable ROM (“EEPROM”), flash memory or other solid-state memory technology, compact disc ROM (“CD-ROM”), digital versatile disk (“DVD”), high definition DVD (“HD-DVD”), BLU-RAY, or other optical storage, magnetic cassettes, magnetic tape, magnetic disk storage, other magnetic storage devices, or any other medium that may be used to store the desired information in a non-transitory fashion.

A mass storage device, such as the mass storage device 228 depicted in FIG. 2, may store an operating system utilized to control the operation of the computing device 200. The operating system may comprise versions of server and/or computing operating systems. Various mobile phone operating systems may also be utilized. It should be appreciated that other operating systems may also be utilized. The mass storage device 228 may store other system or application programs and data utilized by the computing device 200.

The mass storage device 228 or other computer-readable storage media may also be encoded with computer-executable instructions, which, when loaded into the computing device 200, transforms the computing device from a general-purpose computing system into a special-purpose computer capable of implementing the aspects described herein. These computer-executable instructions transform the computing device 200 by specifying how the CPU(s) 204 transition between states, as described above. The computing device 200 may have access to computer-readable storage media storing computer-executable instructions, which, when executed by the computing device 200, may perform methods described herein.

A computing device, such as the computing device 200 depicted in FIG. 2, may also include an input/output controller 232 for receiving and processing input from a number of input devices, such as a keyboard, a mouse, a touchpad, a touch screen, an electronic stylus, or other type of input device. Similarly, an input/output controller 232 may provide output to a display 205, such as a computer monitor, a flat-panel display, a digital projector, a printer, a plotter, or other type of output device. It will be appreciated that the computing device 200 may not include all of the components shown in FIG. 2, may include other components that are not explicitly shown in FIG. 2, or may utilize an architecture completely different than that shown in FIG. 2.

As described herein, a computing device may be a physical computing device, such as the computing device 200 of FIG. 2. A computing node may also include a virtual machine host process and one or more virtual machine instances. Computer-executable instructions may be executed by the physical hardware of a computing device indirectly through interpretation and/or execution of instructions stored and executed in the context of a virtual machine.

### Exemplary Communication Device

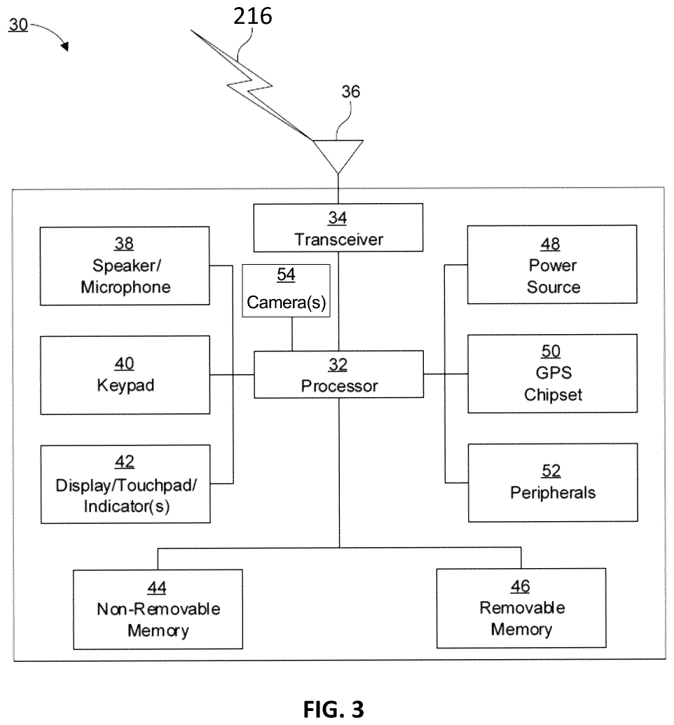

FIG. 3 illustrates a block diagram of an exemplary hardware/software architecture of a communication device such as, for example, user equipment (UE) 30. In some exemplary embodiments, the UE 30 may be any of user devices 106. In some exemplary embodiments, the UE 30 may be a computer system such as for example a cellular telephone, a smartphone, a desktop computer, notebook or laptop computer, netbook, a tablet computer (e.g., a smart tablet), e-book reader, global positioning system (GPS) device, camera, personal digital assistant, handheld electronic device, smart glasses, augmented/virtual reality device, smart watch, or any other suitable electronic device. As shown in FIG. 3, the UE 30 (also referred to herein as node 30) may include a processor 32, non-removable memory 44, removable memory 46, a speaker/microphone 38, a keypad 40, a display, touchpad, and/or indicators 42, a power source 48, a GPS chipset 50, and other peripherals 52. The power source 48 may be capable of receiving electric power for supplying electric power to the UE 30. For example, the power source 48 may include an alternating current to direct current (AC-to-DC) converter allowing the power source 48 to be connected/plugged to an AC electrical receptable and/or Universal Serial Bus (USB) port for receiving electric power. The UE 30 may also include one or more cameras 54. In an exemplary embodiment, the cameras 54 may be smart cameras configured to sense images/videos appearing within one or more bounding boxes. The one or more cameras 54 may capture one or more images/videos indicative of a scene (e.g., from a viewpoint of a user). In other words, the one or more cameras 54 may identify/capture the scene or view which the user sees. The UE 30 may also include communication circuitry, such as a transceiver 34 and a transmit/receive element 36. It will be appreciated the UE 30 may include any sub-combination of the foregoing elements while remaining consistent with an embodiment.

The processor 32 may be a special purpose processor, a digital signal processor (DSP), a plurality of microprocessors, one or more microprocessors in association with a DSP core, a controller, a microcontroller, Application Specific Integrated Circuits (ASICs), Field Programmable Gate Array (FPGAs) circuits, any other type of integrated circuit (IC), a state machine, and the like. In general, the processor 32 may execute computer-executable instructions stored in the memory (e.g., memory 44 and/or memory 46) of the node 30 in order to perform the various required functions of the node. For example, the processor 32 may perform signal coding, data processing, power control, input/output processing, and/or any other functionality that enables the node 30 to operate in a wireless or wired environment. The processor 32 may run application-layer programs (e.g., browsers) and/or radio access-layer (RAN) programs and/or other communications programs. The processor 32 may also perform security operations such as authentication, security key agreement, and/or cryptographic operations, such as at the access-layer and/or application layer for example.

The processor 32 is coupled to its communication circuitry (e.g., transceiver 34 and transmit/receive element 36). The processor 32, through the execution of computer executable instructions, may control the communication circuitry in order to cause the node 30 to communicate with other nodes via the network to which it is connected.

The transmit/receive element 36 may be configured to transmit signals to, or receive signals from, other nodes or networking equipment (e.g., via network 216 (e.g., system 100). For example, in an exemplary embodiment, the transmit/receive element 36 may be an antenna configured to transmit and/or receive radio frequency (RF) signals. The transmit/receive element 36 may support various networks and air interfaces, such as wireless local area network (WLAN), wireless personal area network (WPAN), cellular, and the like. In yet another exemplary embodiment, the transmit/receive element 36 may be configured to transmit and/or receive both RF and light signals. It will be appreciated that the transmit/receive element 36 may be configured to transmit and/or receive any combination of wireless or wired signals.

The transceiver 34 may be configured to modulate the signals that are to be transmitted by the transmit/receive element 36 and to demodulate the signals that are received by the transmit/receive element 36. As noted above, the node 30 may have multi-mode capabilities. Thus, the transceiver 34 may include multiple transceivers for enabling the node 30 to communicate via multiple radio access technologies (RATs), such as universal terrestrial radio access (UTRA) and Institute of Electrical and Electronics Engineers (IEEE 802.11), for example.

The processor 32 may access information from, and store data in, any type of suitable memory, such as the non-removable memory 44 and/or the removable memory 46. For example, the processor 32 may store session context in its memory, as described above. The non-removable memory 44 may include RAM, ROM, a hard disk, or any other type of memory storage device. The removable memory 46 may include a subscriber identity module (SIM) card, a memory stick, a secure digital (SD) memory card, and the like. In other exemplary embodiments, the processor 32 may access information from, and store data in, memory that is not physically located on the node 30, such as on a server or a home computer.

The processor 32 may receive power from the power source 48, and may be configured to distribute and/or control the power to the other components in the node 30. The power source 48 may be any suitable device for powering the node 30. For example, the power source 48 may include one or more dry cell batteries (e.g., nickel-cadmium (NiCd), nickel-zinc (NiZn), nickel metal hydride (NiMH), lithium-ion (Li-ion), etc.), solar cells, fuel cells, and the like. The processor 32 may also be coupled to the GPS chipset 50, which may be configured to provide location information (e.g., longitude and latitude) regarding the current location of the node 30. It will be appreciated that the node 30 may acquire location information by way of any suitable location-determination method while remaining consistent with an exemplary embodiment.

### Exemplary System Operation

The exemplary embodiments may facilitate determining optimized times for particular users associated with a network to be sent one or more content items such, as for example, notifications (e.g., messages, SMS notifications, MMS notifications, emails/email notifications, application based (e.g., a social network application) notifications (e.g., posts, push notifications), etc.). In some examples, the network may be a social network. In this regard, some examples may enable determining a best delivery time for one or more network devices to deliver/provide the content items (e.g., notifications) to the users. In some examples, the best delivery time to deliver/provide the content items (e.g., notifications) may also be determined to be the best time for a particular user to engage/interact with the content items. Additionally, some examples may enable determining generation of candidate content to provide to corresponding users during the best delivery times for the users being determined.

Furthermore, some examples may facilitate monitoring of users' activity patterns associated with a network to determine user activity data associated with corresponding users. In some examples, the user activity data may be based on determined historical user activities of a user. For purposes of illustration and not of limitation, for example, the examples may enable determining an instance(s) in which a user (e.g., user 102) typically visits (e.g., a pattern) a network (e.g., a social network) and/or an instance in which the user typically launches an application (e.g., a social networking app). As such, for example, one or more network devices (e.g., network platform device 115, recommender device 105) may analyze each hour in a day across a time period (e.g., a week, two weeks, a month, etc.) and may determine how likely a user may visit a network and/or launch/open an app and may determine how likely (e.g., the likelihood) the user is to respond to (or engage/interact with) received notifications during time periods in which the user is determined to be most likely to visit the network and/or launch the app. Therefore, some examples may generate/provide a best time prediction service to determine the best time to send one or more notifications (e.g., messages, push notifications, etc.) to users and/or to generate one or more content items for the users to consume (e.g., engage/interact with).

Some examples may enable optimized personalized execution time for scheduled content. For example, the network platform device 115 and/or recommender device 105 may determine at least one best time slot to provide at least one scheduled item of content (e.g., notifications, other content items) for delivery to a user device(s) (e.g., user device 106) associated with a user(s) (e.g., user 102) based on monitored user activities within a network (e.g., system 100). The monitored user activities may be associated with determining the activity of the user(s) interacting with a network (e.g., a social network). The determined at least one best time slot may be stored/saved in a user activity data structure (e.g., a user activity data profile) which may be designated to store determined user activities. In some examples, the user activity data structure including the best time slot and associated user data may be stored in database 130.

In response to determining the at least one best time slot, the network platform device 115 and/or the recommender device 105 may generate one or more optimized time windows to determine one or more time periods for performing scheduled delivery of content items to users. Based on the generated one or more optimized time windows, one or more content items may be predetermined (e.g., scheduled/assigned in advance of the optimized time windows) for delivery of the content items to corresponding users. In some examples, the predetermined content items may be based on a determined priority level of at least one of the content items. The network platform device 115 and/or the recommender device 105 may deliver the (e.g., predetermined) content items to a user device 106 associated with a corresponding user during the at least one determined best time slot. In response to receipt of the content items, the user device 106 may render/display the content items by the display 110. In some examples, the predetermination (e.g., precomputation) of the content items may be determined before the best time slot is determined. In some other examples, one or more optimized time windows (e.g., a four day period) for delivery may include one best time slot (e.g., one of the days in the four day window at a particular time (e.g., 2 PM to 3 PM) of the day). In some examples, a quantity of multiple notifications may be scheduled for delivery during the optimized time window(s) (e.g., the four day period) and a predetermined top ranked content item (e.g., a top ranked notification) may be predetermined to send for delivery to a corresponding user during the best time slot (e.g., 2 PM to 3 PM) of a particular day. The best time slot may be determined to be the best time in which a user may visit a network (e.g., a social network) and/or launch/open an application (e.g., a social network app) and a best time, based on monitored user activity data, that the user is inclined to engage/interact with content. In some examples, the optimized time window(s) and/or best time slot may be determined by the network platform device 115 and/or the recommender device 105.

In some examples, the optimal time window(s)/slots may be the time periods that facilitate achieving optimized product-specific downstream metrics. The optimal time window(s)/slots may be time periods which may minimize infrastructure load such as, for example, minimizing network (e.g., network 101) traffic and minimizing network bandwidth and reducing latency in facilitating content requests and provisioning of content to user devices to avoid overwhelming a network during the execution/delivery of the content items to user devices 106 during the optimized time window(s) and the best time slot. Optimized product-specific downstream metrics may refer to a best time(s) for network delivery of content to devices of users. The best time slot(s)/window(s) prediction of some examples of the present disclosure has been applied by the examples to solve technical issues regarding excessive processing capacity of a network platform device (e.g., network platform device 115) by minimizing/reducing the processing capacity by the network platform device during hours determined to be associated with users' inactivity associated with a network. In this regard, by sending content to user devices across the network during determined best time slots/windows and/or optimal time slots/windows, as opposed to flooding the network with content during times in which users are inactive, such may minimize/reduce the processing capacity of the network platform device (e.g., network platform device 115).

Additionally, the network platform device sending content to user devices across the network during determined best time slots/windows and/or optimal time slots/windows, as opposed to flooding the network with content during times in which users are inactive, enables the examples of the present disclosure to conserve network bandwidth and minimize network traffic congestion across a network (e.g., network 101). Thus, conserving network bandwidth and minimizing network traffic congestion across a network (e.g., network 101) are technical problems solved by the examples of the present disclosure. For example, compared with a hourly computation solution of existing/conventional approaches to generate notifications, the examples of the present disclosure are capable of reducing the service queries per second (QPS) to the network platform device 115 by 60% (thus reducing network traffic and conserving network (e.g., network 101) bandwidth) by utilizing the personalized execution timing optimization approaches of the present disclosure.

In an instance in which promotional notifications may be scheduled for delivery, for example by network platform device 115, one or more corresponding execution timestamps may need to be determined for each of the users designated to receive the promotional notifications so that the promotional notifications may be delivered to each of the users at a right/appropriate time. In this regard, the execution timestamps may indicate at least one time that at least one of the promotional notifications is scheduled for delivery to a corresponding user among each of the multiple users. The range of the execution timestamps and the quantity of associated time slots may be associated with a defined scheduling request and may vary significantly. For purposes of illustration and not of limitation, for example, the time slots associated with the defined scheduling request may vary by being assigned at least once per week to as many times as possible in a day, or other suitable time periods associated with different scenarios. In some examples, the quantity of time slots associated with the scheduling request may be a fixed quantity. In other examples, the quantity of time slots may be personalized and may be based on specific quantity of users designated to receive the content items (e.g., notifications).

For purposes of illustration and not of limitation, scheduling content items delivery timing optimization may, for example, occur in an instance in which a network platform (e.g., a social network platform) such as network platform device 115 plans to send a user one or more notifications about a friend's update on the network platform. In this regard, the network platform device 115 and/or the recommender device 105 may want to determine an instance in which the notification(s) should be sent to the user. The best time slot to send the notification(s) may be determined by the network platform device 115 and/or the recommender device 105. The notification(s) may be scheduled for delivery to the user in advance (e.g., scheduled one day ahead, two days ahead, etc.) of the delivery. In some examples, the notification may be sent via a network platform device (e.g., network platform device 115 (e.g., a server), or from accessing an asynchronous queue. For example, the output of the asynchronous task queue may be to send a notification from the network platform device to a user device associated with a user. The network platform device 115 and/or the recommender device 105 may determine the optimal best time for delivery to avoid a situation in which the notification(s) may be sent at an improper time (e.g., during sleeping, working, or any undesirable time based on a particular user experience), which may result in an undesirable user experience.

In some examples, predetermination for delivery timing optimization for delivery of content items to users may occur in response to the network platform device 115 and/or the recommender device 105 generating candidate content items to be provided to the users for rendering (e.g., displaying) of the content items by the user devices of the users. For example, in an instance in which a user may open an application (e.g., a social network application), the application may need to generate content and render (e.g., display) the generated content to the user. In some conventional approaches in which all of the content determinations may occur after the user opens an application, the generated content may be presented/rendered by the application with significant delay (e.g., greater than 10) seconds, etc.). In some instances, this delay may cause the application to crash and close without presenting the generated content.

The examples of the present disclosure may overcome such a delay scenario (and/or the application crashing) by performing a predetermination (e.g., determining the content in advance of user launching the application) to generate candidate content by the recommender device 105 and/or the network platform device 115, which may occur regardless of the user's online (e.g., network) activity associated with the application. For example, the recommender device 105 and/or the network platform device 115 may generate an event update during previous days (e.g., the previous 7 days) based on, for example, the user's joined groups associated with the application. The recommender device 105 and/or the network platform device 115 may need to determine the time (e.g., in advance of generating the event update) to execute such a task. In situations in which the execution time may be too early or too late, users may experience a delay or lack of a timely update in an instance in which the application is utilized.

In some examples, the recommender device 105 may take as an input a scheduling request, r, which may include the product use case, p, the user, u, and execution time range [tₛₜₐᵣₜ,t_{end}]. Scheduling request, r, may be generated based on a task scheduler request, for example, if a network wants to schedule and send notifications to a user device (e.g., user device 106) associated with a user, the network may initiate a task scheduling request by the network platform device 115. Each request may also include both the number N_{u,p} and length I of time slots to return, where/may partition the execution time range into a set of contiguous candidate time slots [symbol] ={t₁, t₂, . . . , tₖ} (k≥N). For simplicity, it may be considered that N_{u,p} slots returned by the recommender device 105 belong to [symbol] , enabling the equation to be applied to a more general space (e.g., infrastructure off-peak hours) with minor modifications. For example, for purposes of illustration and not of limitation, due to the geographical distribution of users, there may be increased service demand in the morning as opposed to night. Thus, execution of asynchronous tasks may be avoided during the morning hours which may save/conserve processing capacity of network devices of the network (e.g., network platform device 115 and/or recommender device 105). In this example, the night hours may be infrastructure off-peak hours.

The request r may also specify the prediction metric, m, to optimize for, and a best time policy π, which may be a pre-defined policy that acts on a pointwise time slot ranking to generate a final output. This output, [symbol] , may be returned to as a request to the network platform device 115. To prevent a spike in infrastructure load (e.g., to prevent/minimize a spike in bandwidth traffic in system 100 associated with network 101) during the execution, a random delay ϵ∈[0,l) may be applied to actual execution times. This may result in a uniform distribution of execution timestamps within each time slot. To generate the pointwise time slot ranking, a user temporal activity map V_{u,m}, that may map the time slot t to its user-specific predicted value m_{u,t}⁻. This value may be generated by a learned utility function fₘ(u, t). The learned utility function may be a machine learning function and/or an artificial intelligence (AI) learning function executed/implemented by the recommender device 105. These predicted values may be used, by the recommender device 105, to directly rank time slots, or multiple relevant values may be combined via a value model (e.g., a value machine learning model) to generate a pointwise ranking.

Features used to represent a user's activity on each time slot may be important to the performance of the utility predictor fₘ(u, t). The feature vector F(u, t) for each user may include user features, such as the user's profile features (e.g., country, age, etc.), and the user's activity level (e.g., daily active user or non-daily active user, etc.). Daily active uses may logon to an application daily whereas non-daily active users may choose not to logon to the application daily. The feature vector may further include local time features, such as the user's local time transformed from a server-site time slot (e.g., day of the week, hour of the day, sunrise and sunset time, holiday or non-holiday, etc.). In one example, the server-site may be the network platform device 115. The feature vector may also include user activity features, which may represent the ranking signals in the best time ranking problem (e.g., ordering different times for sending content to users from best to worse). User activity features may refer to the user's activity in a given hour or around a time. In some examples, the user activity features as ranking signals may be beneficial as training data for the machine learning of the examples of the present disclosure to rank an order of different times for sending content to a particular user (e.g., whether 3 PM is better than 6 AM to send a notification to a user). With user activity features, the user's historical activity data may be processed to generate the user's activity on the current predicted hour t and nearby hours (e.g., continuous hours from/to the hour t, for example, 1 hour to t, 2 hours to t, etc.), for example, the range may be [t−4 hours, t] and [t, t+4 hours,]. In addition, the 7-day signals may then be aggregated to generate the weekly user hourly activity signals. In an example embodiment, the 7-day signals may be aggregated to generate the weekly user hour activity signals by the recommender device 105.

A series of utility functions, fₘ, may be used to predict, by the recommender device 105, the user's activity m_{u,t} in each time slot on various offsite (e.g., push, email) and in-app channels. Offsite may refer to a delivery channel independent of user activity using an application. In-app channels may refer to notifications or processes delivered to a user during use of an application. These utility functions may fall into the following two categories. One category may be push click models (pClick), where classification models may predict the likelihood of a user, u, clicking the notifications if delivered on the time slot t. For example, the recommender device 105 may utilize the classification models to predict the likelihood (e.g., a 70% probability of clicking, a 75% probability of clicking, etc.) of a user clicking the provided notifications if delivered in time slot t (e.g., between 2 PM-3 PM, etc.).

These utility functions may be utilized with a best time value model. For example, the recommender device 105 may predict the best delivery time to send a user a push notification(s), which may create the need to determine a score(s) for each hour buckets/groups (0, 1 . . . 23) (e.g., each hour within a 24 hour day) to predict the score's impact on the best delivery time. In this example, the normalized user's push content (e.g., notifications) click score (pClick) and the normalized timespent score (SNₜᵢₘₑₛₚₑₙₜ) for each hour bucket/group may be utilized and may need to combine these known values using a best time value model. For example, consider an instance in which pClick is 0.05, SNₜᵢₘₑₛₚₑₙₜ is 0.2 for 8 AM, and the user's activity level (L7) on a social network (SN) is 3 (e.g., the user visited the social network on 3 different dates last week). With these values, an impact score may be determined, by recommender device 105, using the equation pClick+0.1×L7×SNₜᵢₘₑₛₚₑₙₜ, thus generating an impact score associated with 8 AM as 0.05+0.1×3×0.2=0.11. The impact score for each hour of the day may be determined and the 24 hours in a day may be ordered/ranked from best to worst based on the impact score. For instance, the higher an impact score associated with an hour, the higher the corresponding hour may be ranked in relation to other hours in the 24 hour day. The order/rank determined for each hour may enable comparing the respective impact scores of other hours in the 24hour day with the 8 AM impact score (e.g., 0.11) to determine best delivery time (e.g., best delivery time of content). In some examples, the impact score(s) and the order/ranking of the 24 hours in a day may be determined by the network platform device 115 and/or recommender device 105.

To determine a user's activity ranking at 8 AM, in relation to other hours of the day, for example, the recommender device 105 may generate the following ranking features with different hour bucket/group ranges based on the user's historical activity log (e.g., the user's historical activity data). Such hour bucket/group ranges may be as follows.

The user's total activity counter at 8 AM in the past week.
The user's total activity counter at 8 AM in the past month.
The user's total activity counter at 8 AM in the past 3 months.
The user's total activity counter from 6 AM to 8 AM in the past week.
The user's total activity counter from 6 AM to 8 AM in the past month.
The user's total activity counter from 6 AM to 8 AM in the past 3 months.
The user's total activity counter from 8 AM to 10 AM in the past week.
The user's total activity counter from 8 AM to 10 AM in the past month.
The user's total activity counter from 8 AM to 10 AM in the past 3 months.
The user's total activity counter from 4 AM to 8 AM in the past week.
The user's total activity counter from 4 AM to 8 AM in the past month.
The user's total activity counter from 4 AM to 8 AM in the past 3 months.
The user's total activity counter from 8 AM to 12 PM in the past week.
The user's total activity counter from 8 AM to 12 PM in the past month.
The user's total activity counter from 8 AM to 12 PM in the past 3 months.
Or the user's total activity counter in any suitable hour bucket/group determined for logging user historical activity.

The other category of utility functions may be based on activity models, where associated regression models may be utilized to predict scores associated with the user u's metric m on the time slot t. In some examples, the regression models may be utilized by the recommender device 105 to predict the user u's metric m on the time slot t. These scores may be normalized to values [0, 1] by utilizing the equation

$${m}_{u , t}^{-} = \frac{{m}_{u , t} - min ( m )}{max ( m ) - min ( m )} ,$$

where max(m) and min(m) are the maximal and minimal prediction values of metric m (e.g., m_{u,t}⁻) across all users and time slots, respectively.

A utility function activity model for example, may be utilized to determine the normalized SNₜᵢₘₑₛₚₑₙₜ prediction score. In an example, the recommender device 105 may utilize the activity model to determine the normalized SNₜᵢₘₑₛₚₑₙₜ prediction score. From the predicted SNₜᵢₘₑₛₚₑₙₜ score across all users and hour buckets/groups the SNₜᵢₘₑₛₚₑₙₜ max(m) and SNₜᵢₘₑₛₚₑₙₜ min(m) may be determined, for example by the recommender device 105. For this example, in an instance in which the max(m) is 3600 and the minimum value is 0), and the prediction score of a user at 8 AM is 1000, then the normalized value may be

$${m}_{u , t}^{-} = \frac{1000 - 0}{3600 - 0} = 0.28 ,$$

which means this prediction score is 28% of the range between the minimum and the maximum score. The network platform device 115 may then add up various normalized SNₜᵢₘₑₛₚₑₙₜ prediction scores (e.g., 0.28) on the same user u and on the same time slot t (for instance, 8 AM in the e.g., above) in the utility function fₘ(u, t) as the user u's metric m on the time slot t. In this manner, the user u's activity associated with the time slot t may be represented. In some examples, at least a subset of the various normalized SNₜᵢₘₑₛₚₑₙₜ prediction scores that are added up may be associated with multiple data sources to predict the user's activity on the same time slot t and each data source may have a corresponding normalized SNₜᵢₘₑₛₚₑₙₜ prediction score to represent the user u's activity on the same time slot t.

In addition to the utility functions, a “Best Time Policy” technique may be implemented by the examples of the present disclosure. The best time polices may be utilized to determine, by the recommender device 105 and/or network platform device 115, the best time slots based on a temporal activity map of a user and the number of best time slots.

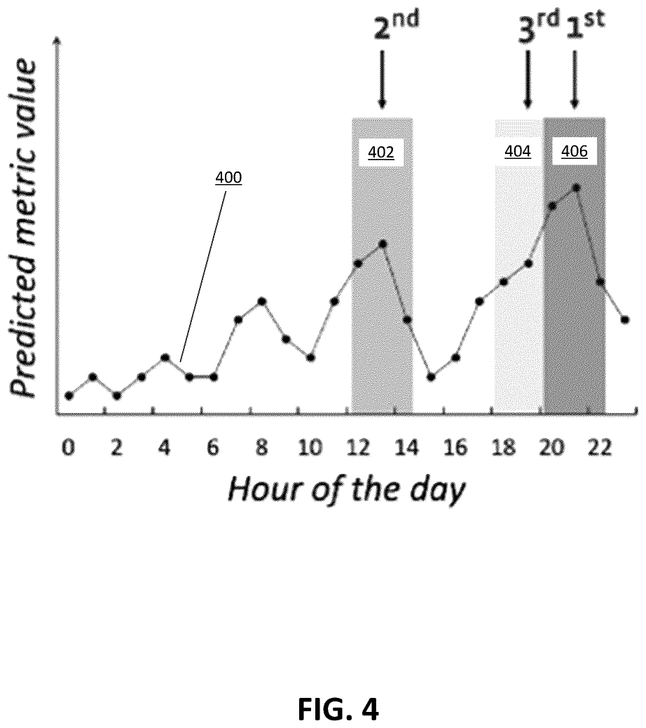

FIG. 4 illustrates a graph depicting determined rankings of best times for scheduled delivery of content items according to an example of an avoid 1-hour nearby policy. The avoid 1-hour nearby policy may, for example, avoid selecting of continuous hours and may ensure that each selected hour is at least one hour apart from each other. The line graph plot 400 may represent the predicted user activity or metric value based on monitored user activity historical data for hours during the day (e.g., hours of the day spanning 0 to 24 hours in FIG. 4), whereas the bar graphs 402, 404, 406 may illustrate time periods or optimized time windows in which it may be best to schedule delivery of content items (e.g., notifications, etc.). In this example, three timestamps or optimal time slots may be determined based on predicted user activity (e.g., the monitored user activity historical data). For instance, in the example of FIG. 4, the recommender device 105 may analyze the user activity data (e.g., associated with plot 400) and determine that the user's highest activity (e.g., user launching an app and/or and interacting with content via the app) occurs in the 21^{st} hour (e.g., 9 PM) associated with bar graph 406. For instance, the predicted metric value is highest during this time as shown in FIG. 4. After 9 PM is selected, by the recommender device 105, the 9 PM timeslot together with its 1-hr nearby time (i.e., 8 PM and 10 PM) from the plot 400 may be blocked off/removed, by the recommender device 105, from being associated with bar graph 406. Additionally, the recommender device 105 may analyze the user activity data (e.g., associated with plot 400) and determine that the user's second highest activity occurs in the 13^{th} hour (e.g., 1 PM) associated with bar graph 402. Similarly, after 1 PM is selected, by the recommender device 105, the 1 PM timeslot may be removed, by the recommender device 105, together with its 1-hr nearby time (i.e., 12 PM and 2 PM) as being associated with bar graph 402. Furthermore, the recommender device 105 may analyze the user activity data (e.g., associated with plot 400) and determine that the user's third highest activity occurs in the 19^{th} hour (e.g., 7 PM) associated with bar graph 404. In this regard, by analyzing the user activity data associated with plot 400, the recommender device 105 may determine the 1^{st}, 2^{nd} and 3^{rd} best time slots (e.g., associated with 9 PM, 1 PM, and 7 PM respectively which are associated with bar graphs 406, 402, 404) for delivery of content items to a user device (e.g., user device 106) of the user.

In the example of FIG. 4, since the recommender device 105 may determine that the user activity data was highest associated with the 1^{st} optimal time slot in the 21^{st} hour, the recommender device 105 may determine that a highest/first ranked generated content item (e.g., a first notification, etc.) is scheduled to be delivered to the user during this time slot. The recommender device 105 may determine that the user has the highest likelihood of interacting with the first ranked generated content item during the 1^{st} optimal time slot. The recommender device 105 may determine the highest likelihood based on a determined highest/first score (e.g., relative to other determined scores associated with the 2^{nd} optimal time slot and the 3^{rd} optimal time slot) associated with determining the predicted user u's metric m, in the manner described above.

Additionally, since the recommender device 105 may determine that the user activity data was second highest (e.g., 2^{nd}) in the 13^{th} hour associated with bar graph 402, the recommender device 105 may determine that a second highest/second ranked generated content item (e.g., a second notification, etc.) is scheduled to be delivered to the user during the 2^{nd} optimal time slot. The recommender device 105 may determine that the user has the second highest likelihood (for example, based on a determined second score that is lower than the highest score associated with determining the predicted user u's metric m) of interacting with the second ranked generated content item during the 2^{nd} optimal time slot. Moreover, since the recommender device 105 may determine that the user activity data was third highest (e.g., 3^{rd}) in the 19^{th} hour associated with the 3^{rd} optimal time, the recommender device 105 may determine that a third highest/third ranked generated content item (e.g., a third notification, etc.) is scheduled to be delivered to the user during the 3^{rd} optimal time slot. The recommender device 105 may determine that the user has the third highest likelihood (for example, based on a determined third score that is lower than the second score associated with determining the predicted user u's metric m) of interacting with the third ranked generated content item during the 3^{rd} optimal time slot. In the example of FIG. 4, a 1-hour nearby best time policy is utilized. However, in other examples, other nearby best time policies (avoid 2-hour nearby, avoid 3-hour nearby, etc.) may be utilized, which avoid selecting continuous hours and make sure each selected hour at least 2 or 3 hours apart from each other, respectively.

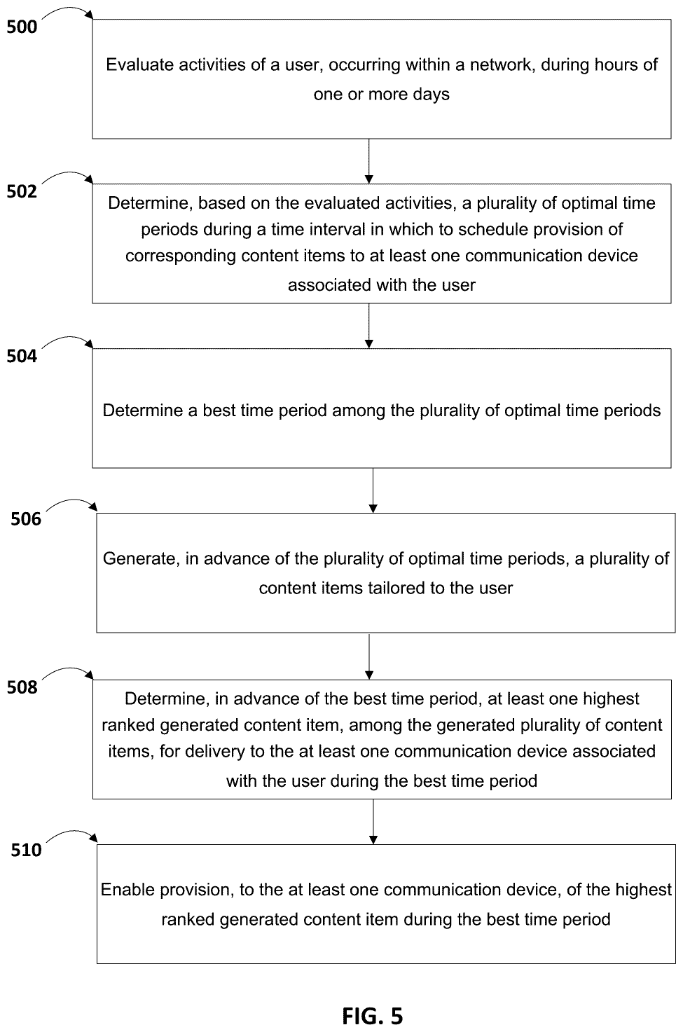

FIG. 5 illustrates an example flowchart illustrating operations for determining personalized execution times for delivery of optimized content according to an example of the present disclosure. At operation 500, a device (e.g., network platform device 115 and/or recommender device 105) may evaluate activities of a user, occurring within a network, during hours of one or more days. In some examples the network may, but need not, be a social network. At operation 502, a device (e.g., network platform device 115 and/or recommender device 105) may determine, based on the evaluated activities, a plurality of optimal time periods during a time interval in which to schedule provision of corresponding content items (e.g., notifications, messages, other content (e.g., images, videos, audio), etc.) to at least one communication device (e.g., user device 106) associated with the user. At operation 504, a device (e.g., network platform device 115 and/or recommender device 105) may determine a best time period (e.g., the 1^{st} optimal time period associated with bar graph 506) among the plurality of optimal time periods. In some examples, the plurality of optimal time periods may be examples of the 1^{st} optimal time period, the 2^{nd} optimal time period and the 3^{rd} optimal time period associated with bar graphs 406, 402, 404, respectively.

At operation 506, a device (e.g., network platform device 115 and/or recommender device 105) may generate, in advance of the plurality of optimal time periods, a plurality of content items tailored to the user. At operation 508, a device (e.g., network platform device 115 and/or recommender device 105) may determine, in advance of the best time period, at least one highest ranked generated content item, among the generated plurality of content items, for delivery to the at least one communication device associated with the user during the best time period. At operation 510, a device (e.g., network platform device 115 and/or recommender device 105) may enable provision, to the at least one communication device, of the highest ranked generated content item during the best time period.

In some other examples, the operations may also include determining, in advance of the plurality of optimal time periods, a second ranked generated content item. This second ranked generated content item may be ranked lower than the highest ranked generated content item, among the generated plurality of content items, for delivery to the at least one communication device. The delivery of the second ranked content item may be for delivery by the device to a user during a second time period of the plurality of optimal time periods. In some other examples, the operations may include determining that a first quantity (e.g., a score associated with determining the user's u metric m) of one or more user activities associated with the user occurring in the network is lower, during the second time period, relative to a second quantity (e.g., a highest score associated with determining the user's u metric m) of user activities associated with the user occurring in the network during the best time period (e.g., the 1^{st} optimal time period associated with bar graph 406). In some examples, the second time period may be associated with the 2^{nd} optimal time period associated with bar graph 402.

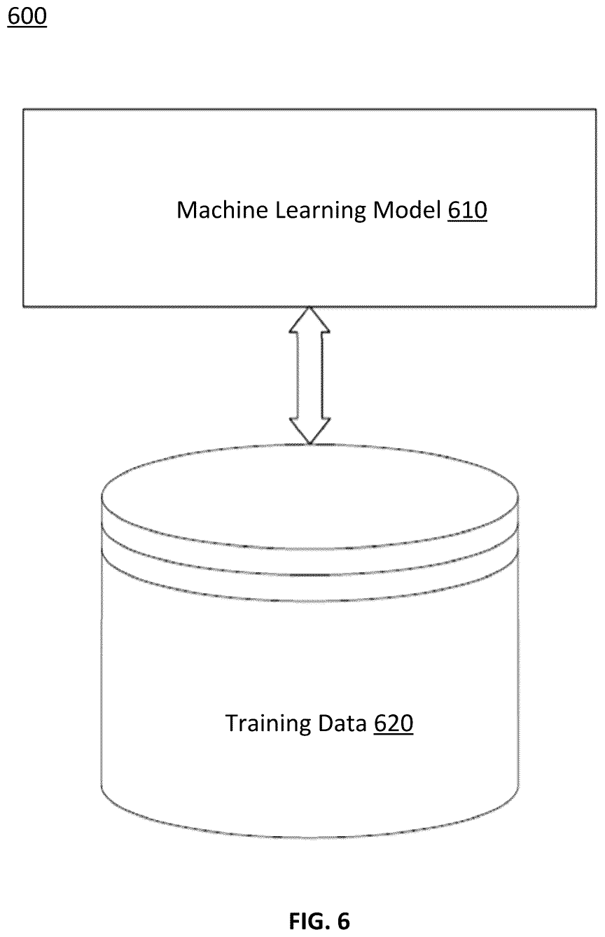

FIG. 6 illustrates a framework 600 employed by a software application for facilitating determination of personalized execution times for delivery of optimized content in some examples. The framework 600 can be hosted remotely. Alternatively, the framework 600 can reside within the network platform device 115 and/or the recommender device 105 shown in FIG. 1 and/or be processed by the computing system 200 shown in FIG. 2. The machine learning model 610 is operably coupled to the stored training data in a database 620. In some examples, the machine learning model 610 may be associated with operations of FIG. 5. In some other examples, the machine learning model 610 may be associated with other operations. The machine learning model 610 may be implemented by one or more machine learning module(s) and/or another device (e.g., network platform device 115 and/or the recommender device 105).

In an example, the training data 620 may include attributes of thousands of objects. For example, the objects may be a smart device (e.g., user device 106), person (e.g., user 102), book, newspaper, sign, car, content items (e.g., messages, notifications, images, videos, audio), and the like. Attributes may include but are not limited to the size, shape, orientation, position of the object, etc. The training data 620 employed by the machine learning model 610 may be fixed or updated periodically. Alternatively, the training data 620 may be updated in real-time based upon the evaluations performed by the machine learning model 610 in a non-training mode. This is illustrated by the double-sided arrow connecting the machine learning model 610 and stored training data 620.

In some examples, the machine learning model 610 may be trained to determine a learned utility function fₘ(u, t) described above. In this regard, the machine learned model 610 may train the learned utility function executed/implemented by the recommender device 105 and/or the network platform device 115. These predicted values may be used, by the recommender device 105 and/or the network platform device 115, to directly rank time slots, or multiple relevant values may be combined via a value model stacking approach (e.g., weights or importance may be learned from machine learning model 610) to generate a pointwise ranking (e.g., treating each ranking object independent of each other in the ranking process). The weights may be weights of each of the predicted values to determine a final user metric m. In this regard, the weights may be associated with an importance of the predicted values to determine the user's activity pattern.

### Alternative Embodiments

The foregoing description of the embodiments has been presented for the purpose of illustration: it is not intended to be exhaustive or to limit the patent rights to the precise forms disclosed. Persons skilled in the relevant art may appreciate that many modifications and variations are possible in light of the above disclosure.

Some portions of this description describe the embodiments in terms of algorithms and symbolic representations of operations on information. These algorithmic descriptions and representations are commonly used by those skilled in the data processing arts to convey the substance of their work effectively to others skilled in the art. These operations, while described functionally, computationally, or logically, are understood to be implemented by computer programs or equivalent electrical circuits, microcode, or the like. Furthermore, it has also proven convenient at times, to refer to these arrangements of operations as modules, without loss of generality. The described operations and their associated modules may be embodied in software, firmware, hardware, or any combinations thereof.

What is claimed:

1. A method comprising:
evaluating activities of a user, occurring within a network, during hours of one or more days:
determining, based on the evaluated activities, a plurality of optimal time periods during a time interval in which to schedule provision of corresponding content items to at least one communication device associated with the user:
determining a best time period among the plurality of optimal time periods:
generating, in advance of the plurality of optimal time periods, a plurality of content items tailored to the user:
determining, in advance of the best time period, at least one highest ranked generated content item, among the generated plurality of content items, for delivery to the at least one communication device associated with the user during the best time period; and
enabling provision, to the at least one communication device, of the highest ranked generated content item during the best time period.

2. The method of claim 1, further comprising:
determining, in advance of the plurality of optimal time periods, a first score indicating a highest likelihood of the user interacting with the highest ranked generated content item during the best time period.

3. The method of claim 1, further comprising:
determining, in advance of the plurality of optimal time periods, a second ranked generated content item, ranked lower than the highest ranked generated content item, among the generated plurality of content items, for delivery to the at least one communication device associated with the user during a second time period of the plurality of optimal time periods.

4. The method of claim 3, wherein the second time period is ranked lower than the best time period.

5. The method of claim 3, further comprising:
determining, in advance of the plurality of optimal time periods, a second score indicating a likelihood, that is lower than the highest likelihood, of the user interacting with the second ranked generated content item during the second time period.

6. The method of claim 3, further comprising:
determining that a first quantity of one or more user activities associated with the user occurring in the network is lower, during the second time period, relative to a second quantity of user activities associated with the user occurring in the network during the best time period.

7. The method of claim 1, wherein the evaluating the activities of the user comprises monitoring historical user activities of the user occurring within the network.

8. The method of claim 1, wherein the network comprises at least one social network in which the user comprises one or more connections to one or more other users.

9. The method of claim 1, wherein the generated plurality of content items comprise one or more notifications, messages or other content generated by the network.

10. A system comprising:
one or more processors: and
one or more memories storing machine-readable instructions that, when executed by the one or more processors, cause the one or more processors to perform operations comprising:
evaluating activities of a user, occurring within a network, during hours of one or more days:
determining, based on the evaluated activities, a plurality of optimal time periods during a time interval in which to schedule provision of corresponding content items to at least one communication device associated with the user;
determining a best time period among the plurality of optimal time periods:
generating, in advance of the plurality of optimal time periods, a plurality of content items tailored to the user;
determining, in advance of the best time period, at least one highest ranked generated content item, among the generated plurality of content items, for delivery to the at least one communication device associated with the user during the best time period; and
enabling provision, to the at least one communication device, of the highest ranked generated content item during the best time period.

11. The system of claim 10, wherein when the one or more processors further execute the instructions, further causes the one or more processors to:
determine, in advance of the plurality of optimal time periods, a first score indicating a highest likelihood of the user interacting with the highest ranked generated content item during the best time period.

12. The system of claim 10, wherein when the one or more processors further execute the instructions, further causes the one or more processors to:
determine, in advance of the plurality of optimal time periods, a second ranked generated content item, ranked lower than the highest ranked generated content item, among the generated plurality of content items, for delivery to the at least one communication device associated with the user during a second time period of the plurality of optimal time periods.

13. The system of claim 12, wherein the second time period is ranked lower than the best time period.

14. The system of claim 12, wherein when the one or more processors further execute the instructions, further causes the one or more processors to:
determine, in advance of the plurality of optimal time periods, a second score indicating a likelihood, that is lower than the highest likelihood, of the user interacting with the second ranked generated content item during the second time period.

15. The system of claim 12, wherein when the one or more processors further execute the instructions, further causes the one or more processors to:
determine that a first quantity of one or more user activities associated with the user occurring in the network is lower, during the second time period, relative to a second quantity of user activities associated with the user occurring in the network during the best time period.

16. The system of claim 10, wherein the evaluating the activities of the user comprises monitoring historical user activities of the user occurring within the network.

17. The system of claim 10, wherein the network comprises at least one social network in which the user comprises one or more connections to one or more other users.

18. The system of claim 10, wherein the generated plurality of content items comprise one or more notifications, messages or other content generated by the network.

19. A computer-readable medium storing instructions that, when executed, cause:
evaluating activities of a user, occurring within a network, during hours of one or more days:
determining, based on the evaluated activities, a plurality of optimal time periods during a time interval in which to schedule provision of corresponding content items to at least one communication device associated with the user:
determining a best time period among the plurality of optimal time periods:
generating, in advance of the plurality of optimal time periods, a plurality of content items tailored to the user:
determining, in advance of the best time period, at least one highest ranked generated content item, among the generated plurality of content items, for delivery to the at least one communication device associated with the user during the best time period; and
enabling provision, to the at least one communication device, of the highest ranked generated content item during the best time period.

20. The computer-readable medium of claim 19, wherein the instructions, when executed, further cause:
determining, in advance of the plurality of optimal time periods, a first score indicating a highest likelihood of the user interacting with the highest ranked generated content item during the best time period.
